(19) United States
(12) Patent Application Publication
(10) Pub. No.: US 2005/0024334 A1
(43) Pub. Date: Feb. 3, 2005

(54) Computer mouse with bristles

(76) Inventors: Fengsheng Li, Scarsdale, NY (US); Wenying Meng, Scarsdale, NY (US); Mengzhan Li, Scarsdale, NY (US)

Correspondence Address: Fengsheng Li, 336 Central Park Ave. J7, Scarsdale, NY, 10583, US

(21) Appl. No.: 10/632,041

(22) Filed: Aug. 1, 2003

(51) Int. Cl. G09G 5/08

(52) U.S. Cl. 345/163

(57) ABSTRACT

A bristled computer mouse is described. The new typed mouse have sparsely populated bristles or teeth on the back, which are meant to facilitate dissipating of heat accumulated under user's palm by prolonged use, and to supply passive or active massaging effects to the user's palm by just holding and using. This new mouse can provide relaxation, stimulation and comfort by releasing the heat, the numbness and fatigue of the palm and hand. By its appearance this type of mouse can also be called a computer hedgehog.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a computer mouse, and in particular to a computer mouse having bristles or call the bristles teeth, which are designed to facilitate the dissipation of heat and provide stimulation, comforts to user's palm.

Through out this description the term bristles and teeth are used interchangeably.

A computer mouse is widely used and associated with a computer main machine as an input device. It functions as a pointer (or call it a cursor) and as a command actuator. It has a variety of different shapes and forms. For example, a flat shaped embodiment look like a real animal mouse, hence its name got derived. Since the popularity of PC computers, various mice designed to improve efficiency, comfort, and health have been designed and patented. For example, A vertical embodiments come in consideration for the positioning of fingers, wrist and arm related to the overuse injury (U.S. Pat. No. 6,492,975, December 2002, to Weiss) has been described. There are a series of ergonomic mice designed to meet many particular needs (ig. U.S. Pat. No. 6,556,150, April 2002, to McLoone et al.; U.S. Pat. No. 6,509,891, January 2003, to Sheehan et al. al.; U.S. Pat. No. 6,489,947, December 2002, to Hesley; U.S. Pat. No. 6,441,805, August 2002, to Reid et al.; U.S. Pat. No. 6,441,770, August 2002, to Russell; U.S. Pat. No. 6,396,479, May 2002, to Gordon; U.S. Pat. No. 6,377,244, April 2002, to Reid et al.; U.S. Pat. No. 6,362,811, March 2002, to Edwards et al.; U. S. Pat. No. 6,262,715, July 2002, to Sawyer; U.S. Pat. No. 5,966,118, October 1999, to Miyakawa). Other different shaped mice also got devised, for example, an orthopedic computer mouse (U.S. Pat. No. 6,532,002, March 2003, to Segalle), finger rest structured computer mouse (U.S. Pat. No. 5,990,870, November 1999, to Chen et al), and computer mouse with massaging function (U.S. Pat. No. 6,323,841, November 2001, to Lai) have all been described and patented.

Still, other different designed mice exist, such as of a computer mouse consists of a platform and a ball on top; pointing in that type of mouse is achieved by turning the ball on top. Also computer mice are designed in various shapes, such as rectangular, circular, curved and twisted, mixed circular and angular, with cord and cordless. The surface can be flat, convex or concave. Mice can also be in a conceptual sense, for example, mice for laptop computers can vary greatly, and by appearance can be far from any similarity with a real animal mouse.

Although great efforts have been put in designing of mouse to give comforts and to decrease fatigue or injury in addition to its fundamental function as a pointer and command actuator, problems associated with the prolonged use of mouse still exist and remain unresolved. One problem associated with the use of mice in hot or moderate temperature, or in prolonged use is that the heat accumulated under user's palm, and the numbness of the palm and the hand. These problems are annoying to the least and affect the health and well being of users to the extreme cases. Those problems can interrupt the normal computer operations or work. So, improvements with consideration of the above problems are really needed. It would be very desirable to have a mouse that can cool the palm by facilitating ventilation or by direct cooling device, and at the same time to give some kinds of relaxation and stimulation to the numb and fatigue of the palm and hand.

The present invention, the bristled or teethed mouse is specifically designed with the above problems in mind. It can cool the hand by dissipating the heat, and at the same time provide passive or active massaging of the palm through the bristles so that to offer relaxation and stimulation just by holding and using the mouse. Most significantly, the bristled mouse is very simple and easy to implement in its basic embodiment.

### BRIEF SUMMARY OF THE INVENTION

The present invention overcomes the aforementioned shortcomings of the prior arts by making the mouse with bristles of right height, and of right population. This novel mouse can facilitate dissipation of the heat accumulated under the palm of the user through good ventilation in the space between the bristles, and also at the same time can provide the passive soothing, relaxation and stimulation for the palm through the bristles. The bristles are designed in sharpness and material not dangerous to the user. By this novel design the mouse can deliver the aforementioned benefits. By it appearance, this type of mouse can also be called a computer hedgehog.

### BRIEF DESCRIPTION OF THE SEVERAL VIEWS OF THE DRAWING

FIG. 1 is a perspective view of a computer mouse having bristles in a preferred embodiment.

FIG. 2 is a side view of a computer mouse having bristles in a preferred embodiment.

### DETAILED DESCRIPTION OF THE INVENTION

The following one of the preferred embodiment is merely exemplary of the invention, it is meant to facilitate understanding of the present invention.

The term of bristles is used interchangeably with the term teeth throughout.

The said invention may be embodied in various forms, therefore, the specific structural and functional details described below and thereafter are not to be interpreted as limiting, but rather as a representative base to get ones that are skilled in the art to employ and implement the present invention in any appropriately detailed system or structure. It will be understood that the drawing are not necessary to the scale, and relative component part sizes may be exaggerated just to make understanding of this invention easy.

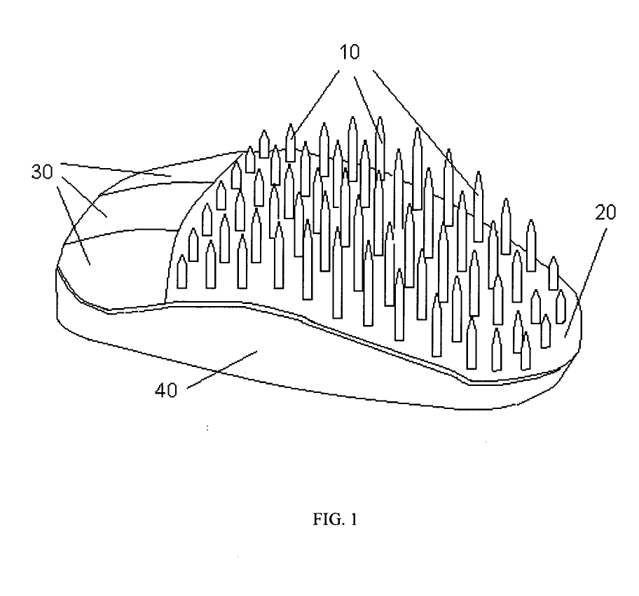

FIG. 1 depicts a perspective view of a preferred embodiment of the present invention. A computer mouse has bristles to facilitate cooling and to provide massaging effects to user's palm. The bristles are pointed by number 10. All the bristles are seated on a base as pointed by number 20. Other necessary parts make the mouse to function as a pointer and command actuator, such as the click button or buttons pointed by number 30, and a mouse body base platform pointed by number 40. The height and sharpness of the bristles are optimal for regular hand, and can be made in different length and sharpness such that to deliver the most comfort for the palm. The population of the bristles can be sparse or dense to facilitate fast ventilation and dissipation of the heat accumulated under the user's palm, and also to deliver the passive massaging, stimulation to the user's palm. The overall effects of the bristles are to cool the palm, to reduce the numbness and fatigue associated with prolonged use of mouse. The formation of the bristles can also be varied, such as in straight matrix style, or in zigzag lining style.

The bristles are designed and are made with materials not to cause any injury to the user with proper use.

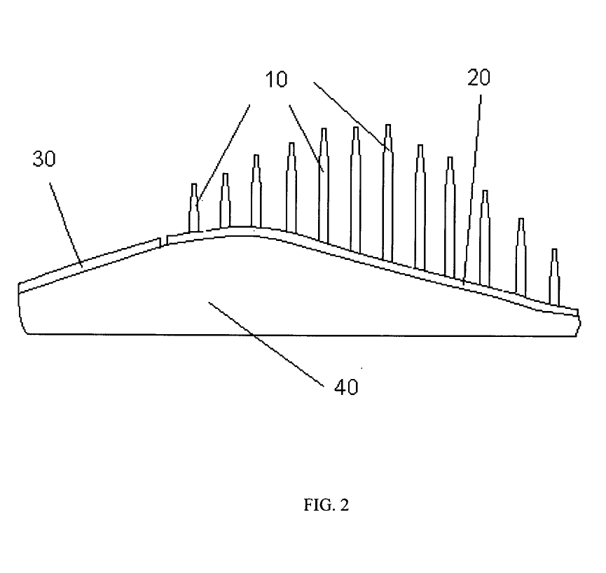

FIG. 2 is a side view of the preferred embodiment. As shown in the figure, the bristles form a curved surface contour in similarity to user's palm such that to deliver the most benefits. However that contour shape can be in any form. The height of the bristles can vary; the shape of each bristle can also vary, for example they can be straight or wavy. The surface formed by the bristles can be in any style, convex, concave, flat, or wavy. The base area that holds the bristles can also take any shape, such as circular, rectangular, or mixed angular and curve.

1. A bristled or call it teethed computer mouse comprising:
(a) A top part which has bristles or call the bristles teeth;
(b) Parts supplying conventional mouse functions; such as click buttons, roll and body base platform.

2. As in claim 1, the said mouse further comprising a motorized vibrator to deliver active massaging, and active stimulation to the user's palm.

3. As in claim 1, the said mouse further comprising a motorized cooler to deliver active cooling to the user's palm.

4. As in claim 1, wherein, each bristle has a little ball on the tip to reduce the sharpness of the bristles.

5. As in claim 1, wherein, each bristle is itself a cluster of thinner bristles of natural or man-made materials.

6. A bristled or call it teethed computer mouse comprising:
(a) A removable top part which has bristles;
(b) A bottom part supplying the necessary grooves to join with the bristled part;
(c) Parts supplying conventional mouse functions; such as click buttons, roll and body platform.

7. As in claim 6, the said-mouse, wherein the removable part is an assembly, which contains the necessary grooves for mounting the bristles, so that to facilitate cleaning and to make removing the bristles easy when user does not want the bristles and want to convert to a regular mouse without bristles.

8. As in claim 6, the said mouse further comprising a motorized vibrator to deliver active massaging, and active stimulation to user's palm.

9. As in claim 6, the said mouse further comprising a motorized cooler to deliver active cooling to user's palm.

10. A bristled computer mouse comprising:
(a) A bristled coat;
(b) Parts supplying conventional mouse functions, such as clicking buttons, roll, and platform;
(c) Necessary hooks, grooves for fastening the bristled coat.

11. As in claim 10, the said mouse further comprising a motorized vibrator to deliver active massaging, and active stimulation to user's palm.

12. As in claim 10, the said mouse further comprising a motorized cooler to deliver active cooling to user's palm.
